(19) United States
(12) Patent Application Publication
(10) Pub. No.: US 2009/0150931 A1
(43) Pub. Date: Jun. 11, 2009

(54) Display control apparatus, display control method, and program

(75) Inventor: Nobuyuki Fujiwara, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/315,966

(22) Filed: Dec. 8, 2008

(30) Foreign Application Priority Data
Dec. 10, 2007 (JP) P2007-318241

(51) Int. Cl. H04N 5/445

(52) U.S. Cl. 725/39

(57) ABSTRACT

A display control apparatus includes an acquisition section acquiring EPG data, an extraction section extracting a sentence formed by a plurality of words from information of each item of content included in the EPG data acquired by the acquisition section, and a display control section causing the sentence extracted by the extraction section to be displayed on a list of content and accepting selection of an item of content.

### CROSS REFERENCES TO RELATED APPLICATIONS

The present invention contains subject matter related to Japanese Patent Application JP 2007-318241 filed in the Japanese Patent Office on Dec. 10, 2007, the entire contents of which being incorporated herein by reference.

### BACKGROUND OF THE INVENTION

1. Field of the Invention

The present invention relates to a display control apparatus, a display control method, and a program. More particularly, the invention relates to a display control apparatus, a display control method, and a program which allow an item of content to be selected with an outline of the item checked with reference to displayed sentences.

2. Description of the Related Art

A digital picture-recording apparatus such as a hard disk recorder allows a user to select a program from a program table displayed based on EPG (Electric Program Guide) data and to make a setting for timed recording of the program.

For example, when the program table is displayed in the form of a radio/TV program list, the user can check what programs are broadcast in which time zones from brief information displayed in columns showing program titles and the like. When the user is interested in a certain program, the user can select the program and perform a predetermined operation to have detailed information of the program such as people featured in the program and an outline of the program displayed.

With reference to such information, the user can select a program to be set for timed recording.

JP-A-2005-223940 (Patent Document 1) discloses a technique as described below. Let us assume that information representing titles associated with programs provided for displaying a program table includes two types of information, i.e., program titles such as “Friday Movie Theater” and information indicating the content of programs such as a movie title. In such a case, the technique allows the latter information, i.e., the information indicating the content of programs to be displayed on the program table.

### SUMMARY OF THE INVENTION

When a program is selected as described above, the user needs to have detailed information of each program displayed to check the content of the broadcast program by reading sentences describing details such as an outline of the program.

It takes some time and labor to have such detailed information displayed and to read it, which makes it troublesome to select a program based on the content of the same.

Under the circumstance, it is desirable to allow an item of content to be selected with an outline of the item checked with reference to displayed sentences.

According to an embodiment of the invention, there is provided a display control apparatus including an acquisition section acquiring EPG data, an extraction section extracting a sentence formed by a plurality of words from information of each item of content included in the EPG data acquired by the acquisition section, and a display control section causing the sentence extracted by the extraction section to be displayed on a list of content and accepting selection of an item of content.

According to the embodiment of the invention, the extraction section may extract a sentence having a mark indicating that the sentence is an update of a sentence which has been included in the first information provided in EPG data, among sentences included in information of each item of content.

According to the embodiment of the invention, when a plurality of sentences are extracted from information of one item of content by the extracting section, the display control section causes each of the plurality of extracted sentences to be displayed on the list of content.

According to the embodiment of the invention, when the one item of content is selected from any of the plurality of sentences outlining the item of content extracted from the information of the item of content, the display control section provides an indication showing that the items of content outlined by the plurality of respective sentences are items of content which have already been selected.

According to another embodiment of the invention, there is provided a display control method including the steps of acquiring EPG data, extracting a sentence formed by a plurality of words from information of each item of content included in acquired EPG data, and causing the extracted sentence to be displayed on a list of items of content to accept selection of an item of content.

According to still another embodiment of the invention, there is provided a program which causes a computer to execute a process including the steps of acquiring EPG data, extracting a sentence formed by a plurality of words from information of each item of content included in acquired EPG data, and causing the extracted sentence to be displayed on a list of items of content to accept selection of an item of content.

According to the embodiment of the invention, a user can select an item of content with an outline of the item checked with reference to displayed sentences.

### BRIEF DESCRIPTION OF THE DRAWINGS

FIG. 1 is an illustration showing an example of a display control apparatus according to an embodiment of the invention;

FIG. 2 shows a flow of processes performed by the display control apparatus;

FIG. 3 is an illustration showing an example of display of a program list;

FIG. 4 is a block diagram showing an example of a hardware configuration of the display control apparatus;

FIG. 5 is a block diagram showing an example of a functional configuration of the display control apparatus;

FIG. 6 shows an example of text data included in information of a program;

FIG. 7 is a flow chart for explaining all processes performed by the display control apparatus;

FIG. 8 is a flow chart for explaining a pre-filtering process performed at step S2 shown in FIG. 7;

FIG. 9 is an illustration showing an example of information of a program;

FIG. 10 is an illustration showing another example of a program list.

FIG. 11 is an illustration showing still another example of a program list.

### DESCRIPTION OF THE PREFERRED EMBODIMENTS

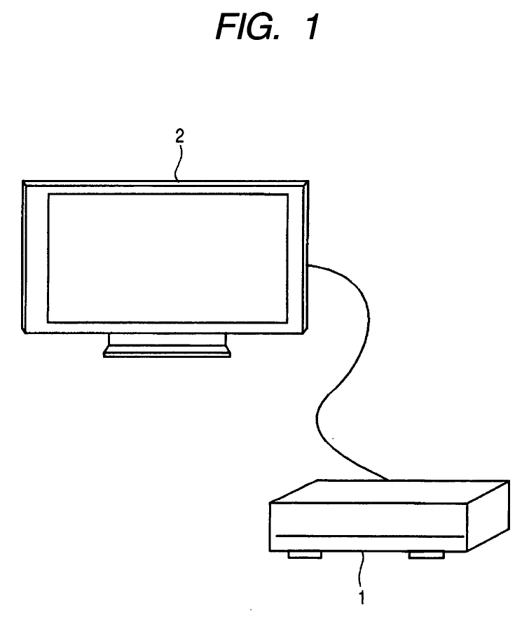

FIG. 1 is an illustration showing an example of a display control apparatus 1 according to an embodiment of the invention.

The display control apparatus 1 is a digital picture-recording apparatus incorporating a hard disk. The display control apparatus 1 acquires data of programs (content) provided by BS (Broadcasting Satellite)/CS (Communication Satellite) digital broadcasts, digital terrestrial broadcasts, or broadcasts through the internet and records the acquired program data in the hard disk. Signals from an antenna, which is not shown, are supplied to the display control apparatus 1. The display control apparatus 1 reproduces the data recorded in the hard disk according to an instruction from a user to output pictures and sounds of a program from a television receiver 2.

The display control apparatus 1 acquires EPG data distributed by broadcast stations and the like using broadcast waves or internet. EPG data includes information of each program scheduled to be broadcast, such as the title of the program, the day and time of broadcast, a code representing the category of the program, and detailed information of the program. The detailed information includes the names of people featured in the program, the names of features of the program, and an outline of the program.

EPG data including such information is distributed a plural number of times a day at predetermined times of the day, the data being a collection of information of programs scheduled to be broadcast in eight days including the day when the EPG data is distributed.

For example, EPG data distributed on March 1 includes information of programs scheduled to be broadcast from March 1 through March 8, and EPG data distributed on March 2 includes information of programs scheduled to be broadcast from March 2 through March 9. Therefore, information of a program broadcast on a certain day is provided every day from the day seven days before the broadcast through the day of broadcast.

In the case of a program belonging to a category such as news, the content of the program is finally decided shortly before the day of broadcast. Therefore, information provided first as information of a news program or the like may be different from information of the program that is provided later. As will be described later, information which is an update of previous one is added with a piece of information indicating such a history.

The display control apparatus 1 acquires and manages each item of EPG data distributed. The EPG data managed by the display control apparatus 1 is used to display a list of programs scheduled to be broadcast. On the program list, lines of sentences extracted from information included in the EPG data are displayed as information of programs scheduled to be broadcast. A user can select a program to be set for timed recording from the program list.

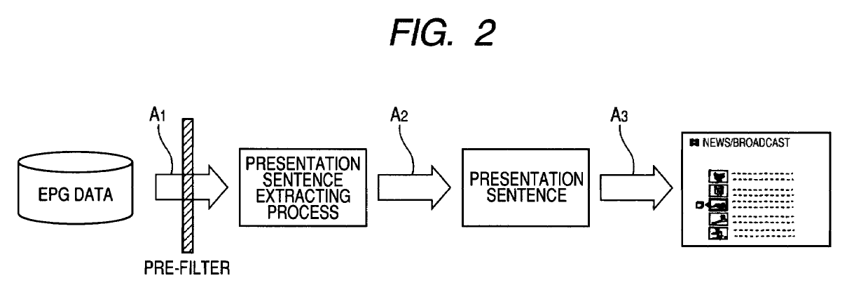

FIG. 2 shows a flow of processes performed by the display control apparatus 1 to display a program list.

As indicated by arrow A₁ in FIG. 2, a pre-filtering process is performed on EPG data which has been distributed and saved. The pre-filtering process is a pre-process for a process of extracting presentation sentences to be presented on a program list. The pre-filtering process deletes characters, symbols, and the like which are inappropriate to be used to form presentation sentences. The process may also narrows down the data to obtain information of programs which meet specified conditions on broadcast networks, broadcast starting dates, and program categories.

EPG data on which the pre-filtering process is carried out is, for example, SI-EPG data for digital broadcasts implemented or run in compliance to standard specifications defined in ARIB (Association of Radio Industries and Businesses) STD-B10 or technical data specified in ARIB TR-B14/15.

Instead of performing the process on all items of EPG data that is saved, the process may be performed on limited items of data selected in relation to a certain day which constitutes a reference day. Specifically, the process may be performed only on information of programs scheduled to be broadcast on the reference day among items of EPG data distributed on the reference day. Alternatively, the process may be performed only on information of programs scheduled to be broadcast on the day after the reference day among items of EPG data distributed on the day before the reference day.

A process of extracting presentation sentences is performed on EPG data obtained by the pre-filtering process according to a pattern defined in advance. Extracted presentation sentences pointed by arrow A₂ are used to display a program list as pointed by arrow A₃.

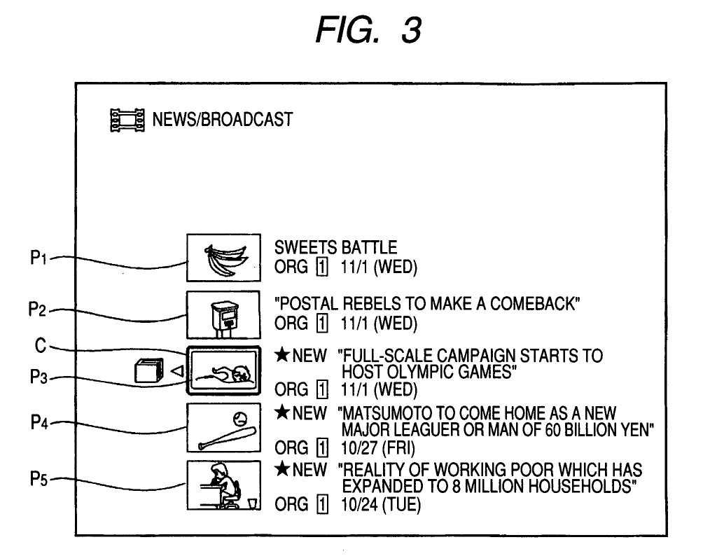

FIG. 3 is an illustration showing an example of a program list displayed on the television receiver 2.

A description will now be made on a case in which a list of news programs is displayed. As described above, information of each program included in EPG data includes information indicating the category of the program. For example, when a user gives an instruction for display of news programs scheduled to be broadcast, a screen as shown in FIG. 3 is displayed.

In the program list shown in FIG. 3, pictures P₁ to P₅ displayed in a vertical arrangement are pictures representing respective news programs provided in EPG data. When no representative picture is provided for a program, only a picture-frame may be displayed without a picture.

The sentence “Sweets Battle” displayed on the right side of the picture P₁ is a presentation sentence extracted from information of a news program scheduled to be broadcast on November 1 and represented by the picture P₁. A presentation sentence is formed by a plurality of words.

Similarly, the sentence “Postal rebels to make a comeback” displayed on the right side of the picture P₂ is a presentation sentence extracted from information of a news program scheduled to be broadcast on November 1 and represented by the picture P₂. The sentence “Full-scale campaign starts to host Olympic games” displayed on the right side of the picture P₃ is a presentation sentence extracted from information of a news program scheduled to be broadcast on November 1 and represented by the picture P₃.

The sentence “Matsumoto to come home as a new major leaguer or man of 60 billion yen” displayed on the right side of the picture P₄ is a presentation sentence extracted from information of a news program scheduled to be broadcast on October 27 and represented by the picture P₄. The sentence “Reality of working poor which has expanded to 8 million households” displayed on the right side of the picture P₅ is a presentation sentence extracted from information of a news program scheduled to be broadcast on October 24 and represented by the picture P₅.

As thus described, on a program list displayed by the display control apparatus 1, presentation sentences extracted from information of news programs included in EPG data are displayed in lines one sentence per program instead of displaying the title of each news program.

Thus, a user can select a program to be set for timed recording based on the content of the programs by reading the presentation sentences to have a brief understanding of the content of the programs. In selecting a program to be set for timed recording, it is not necessary to check the content of the program in detail. In most cases, selection can be sufficiently made only by checking a summary of the content that is simple enough to be represented by one sentence.

The user moves a cursor C that is displayed so as to overlap the representative pictures by operating a remote controller. Thus, the user can perform a predetermined operation to make a setting for timed recording of the program associated with a representative picture selected using the cursor C as described above. When the setting for timed recording is made, a picture (mark) is displayed in the vicinity of the information of the program selected by the user to indicate that the program has been set for timed recording.

Processes performed by the display control apparatus 1 to display a program list as described above will be described later with reference to a flow chart.

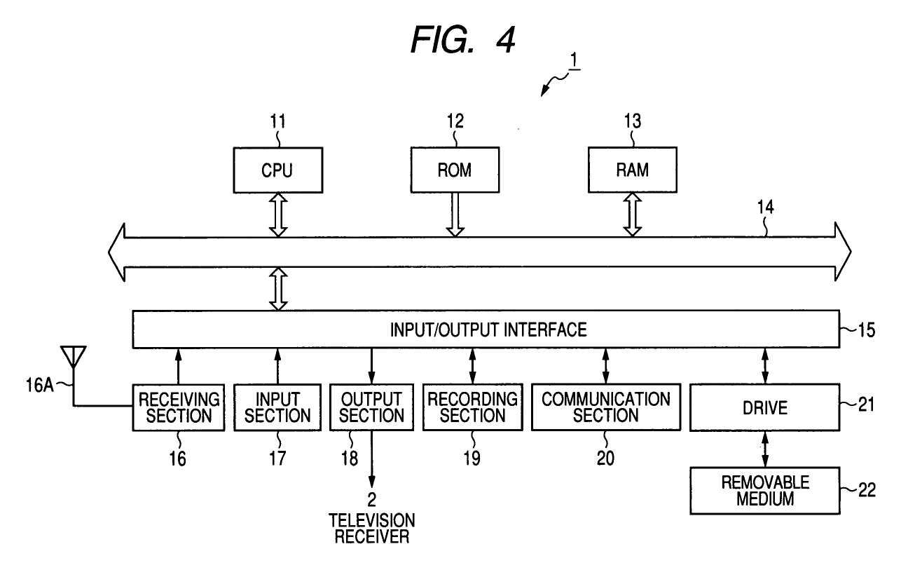

FIG. 4 is a block diagram showing an example of a hardware configuration of the display control apparatus 1.

A CPU (Central Processing Unit) 11 executes various processes according to a program recorded in a ROM (Read Only Memory) 12 or a recording section 19. The program and data executed and used by the CPU 11 are recorded in a RAM (Random Access Memory) 13 as occasion demands. The CPU 11, the ROM 12, and the RAM 13 are connected to each other through a bus 14.

An input/output interface 15 is connected to the CPU 11 through the bus 14. A receiving section 16, an input section 17, an output section 18, the recording section 19, a communication section 20, and a drive 21 are connected to the input/output interface 15.

The receiving section 16 receives and demodulates a broadcast wave signal from an antenna 16A to acquire an MPEG-TS (Moving Picture Experts Group-Transport Stream). The receiving section 16 acquires the data of the program to be recorded and EPG data from the MPEG-TS and outputs the acquired data to the recording section 19 through the input/output interface 15.

The input section 17 receives signals from a remote controller and outputs information representing the content of user operations to the CPU 11 through the input/output interface 15 and the bus 14.

The output section 18 decodes the data of a program for which an instruction for reproduction has been received and causes the television receiver 2 to display pictures of the program based on picture signals thus obtained. Further, the output section 18 causes the television receiver 2 to display a program list as shown in FIG. 3 under control exercised by the CPU 11.

The recording section 19 is, for example, a hard disk which records programs to be executed by the CPU 11 and various data such as program data and EPG data supplied from the receiving section 16 through the input/output interface 15.

The communication section 20 communicates with a server to acquire data of programs distributed by internet broadcasts and EPG data distributed by the server. The communication section 20 outputs the data thus acquired to the recording section 19 through the input/output interface 15 to record the data.

The drive 21 drives a removable medium 22 such as an optical disk or semiconductor memory mounted therein to acquire a program and data recorded in the medium. The acquired program and data are transferred to the recording section 19 to be recorded as occasion demands.

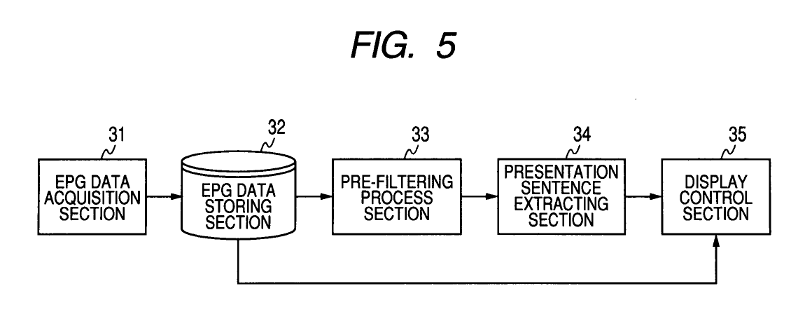

FIG. 5 is a block diagram showing an example of a functional configuration of the display control apparatus 1. At least some of the functional sections shown in FIG. 5 are implemented through the execution of a predetermined program by the CPU 11 shown in FIG. 4.

As shown in FIG. 5, an EPG data acquisition section 31, an EPG data storing section 32, a pre-filtering process section 33, a presentation sentence extracting section 34, and a display control section 35 are provided in the display control apparatus 1.

The EPG data acquisition section 31 controls the receiving section 16 to acquire EPG data repeatedly distributed through digital broadcasts or the like. The EPG data acquisition section 31 outputs the acquired EPG data to the EPG data storing section 32 to store the data therein.

The EPG data supplied by the EPG data acquisition section 31 is stored in the EPG data storing section 32. The EPG data stored in the EPG data storing section 32 is rewritten, for example, each time the latest EPG data are supplied from the EPG data acquisition section 31. The latest information of programs scheduled to be broadcast in eight days including the day of distribution of the EPG data is stored in the EPG data storing section 32.

The pre-filtering process section 33 performs a pre-filtering process to delete characters and symbols which are inappropriate to be used to form presentation sentences from information of programs included in the EPG data stored in the EPG data storing section 32. The section also narrows down the data to obtain information of programs which meet predetermined conditions specified as occasion demands. The pre-filtering process section 33 outputs EPG data obtained by performing the pre-filtering process to the presentation sentence extracting section 34.

The presentation sentence extracting section 34 extracts a presentation sentence from information of each program included in the EPG data supplied from the pre-filtering process section 33.

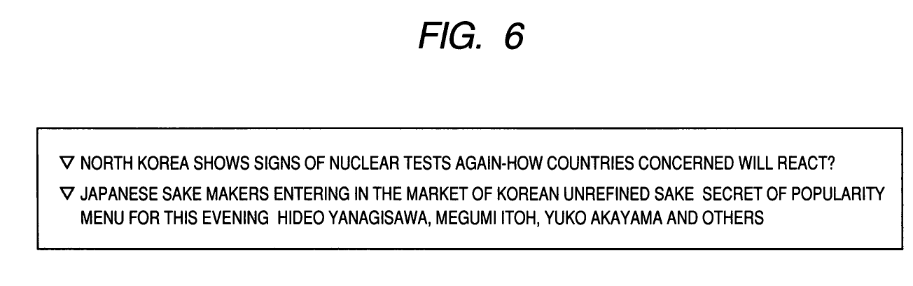

FIG. 6 shows an example of text data included in information of a certain news program.

As described above, EPG data includes various types of text data as information of each program, such as the names of people featured in the program, the names of features of the program, and a sentence representing the content of the program. In the example shown in FIG. 6, the EPG data includes text data “North Korea shows signs of nuclear test again. How countries concerned will react?”, “Japanese sake makers entering into the market of Korean unrefined sake”, “Secret of popularity”, “Menu for this evening”, and “Hideo Yanagisawa, Megumi Itoh, Yuko Akayama and others”.

A downward-pointing white triangular mark (∇), which will be hereinafter simply referred to as “triangular mark”, is shown at the beginning of each of the texts “North Korea shows signs of nuclear test again. How countries concerned will react?” and “Japanese sake makers entering into the market of Korean unrefined sake”. A space is inserted between the texts “Japanese sake makers entering into the market of Korean unrefined sake” and “Secret of popularity”, between the texts “Secret of popularity” and “Menu for this evening”, and between the texts “Menu for this evening” and “Hideo Yanagisawa, Megumi Itoh, Yuko Akayama and others”.

For example, when a presentation sentence extracting process is performed on such text data, the text data having the triangular marks are regarded as presentation sentences. The text data of presentation sentences are sliced out using the triangular marks as separators.

A triangular mark indicates that the text data the mark is attached has not been included in first EPG data distributed seven days before the day of broadcast. That is, the mark indicates that the text data is an item of data which has been added or updated during the period before the day of broadcast.

In most cases, text data such as names of features of a program and names of people featured in the program included in program information are fixed when EPG data including the information of the program is first distributed. Therefore, names of features and names of featured people as thus described are rarely updated and are therefore rarely accompanied by a triangular mark.

Let us assume that the extracting process sequentially checks the characters starting with the character at the beginning of the text data. When no triangular mark is put at the beginning of the data, the text data from the character at the beginning up to the character before the position of the first triangular mark is regarded as a presentation sentence and is therefore sliced out.

Text data following the last triangular mark included in program information is sliced out as a presentation sentence up to the position where the next space is inserted.

In the example shown in FIG. 6, the text data “North Korea shows signs of nuclear test again. How countries concerned will react?” residing between the first triangular mark provided at the beginning and the second triangular mark is regarded as a presentation sentence and is therefore sliced out.

The second triangular mark is the last one of the triangular marks included in the text data shown in FIG. 6. Therefore, the text data from the second triangular mark up to the next space, i.e., the space inserted between “Japanese sake makers entering into the market of Korean unrefined sake” and “Secret of popularity” is regarded as a presentation sentence and sliced out. That is, the text data “Japanese sake makers entering into the market of Korean unrefined sake” is regarded as a presentation sentence and sliced out.

Each of the items of text data “Secret of popularity”, “Menu for this evening”, and “Hideo Yanagisawa, Megumi Itoh, Yuko Akayama and others” following “Japanese sake makers entering into the market of Korean unrefined sake” added with no triangular mark is not regarded as a presentation sentence. Those items of text data are excluded from the object of slicing.

Such a process is performed on information of each program included in EPG data obtained as a result of the pre-filtering process. A presentation sentence extracted as thus described is supplied from the presentation sentence extracting section 34 to the display control section 35 along with information indicating the program information from which the sentence has been extracted.

Referring to FIG. 5 again, when the user gives an instruction for the display of a program list, the display control section 35 reads the representative picture of each program and information of the day of broadcast of the program from the EPG data storing section 32 and causes the television receiver 2 to display the pieces of information thus read by controlling the output section 18. The display control section 35 also causes the television receiver 2 to display presentation sentences extracted by the presentation sentence extracting section 34 from the program information including representative pictures.

Processes performed by the display control apparatus 1 having the above-described configuration will now be described.

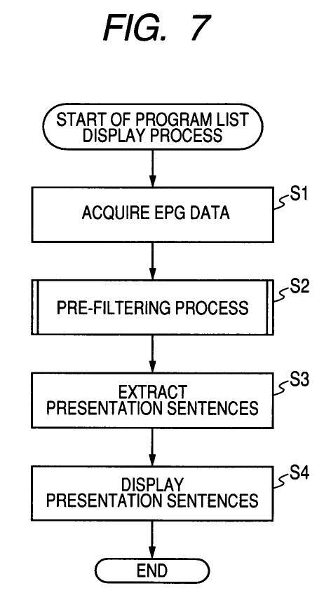

First, a description will be made with reference to the flow chart in FIG. 7 on all processes performed by the display control apparatus 1 to display a program list.

At step S1, the EPG data acquisition section 31 acquires EPG data repeatedly distributed through digital broadcasts and the like and stores the acquired EPG data in the EPG data storing section 32.

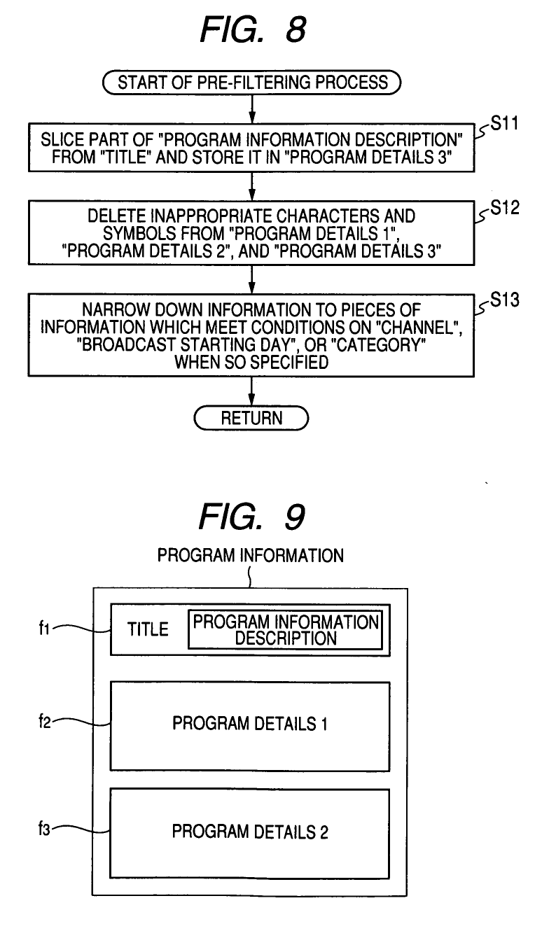

At step S2, the pre-filtering process section 33 performs a pre-filtering process. EPG data obtained by performing the pre-filtering process are supplied from the pre-filtering process section 33 to the presentation sentence extracting section 34. Details of the pre-filtering process will be described later with reference to the flow chart in FIG. 8.

At step S3, the presentation sentence extracting section 34 extracts a presentation sentence from information of each program included in the EPG data supplied from the pre-filtering process section 33, for example, using downward-pointing white triangular marks as separators as described above. The presentation sentence extracting section 34 outputs the extracted presentation sentences to the display control section 35.

At step S4, in response to a user's instruction for the display of a program list, the display control section 35 causes the television receiver 2 to display pieces of information of each program, i.e., the representative picture, the day of broadcast, and a presentation sentence extracted by the presentation sentence extracting section 34, as shown in FIG. 3. When the user gives an instruction for recording of a predetermined program, a picture-recording management section (which is not shown) accepts the instruction, makes a setting for timed recording, and manages the recording.

The pre-filtering process at step S2 and the presentation sentence extracting process at step S3 may be carried out after a user gives an instruction for display of a program list. Those processes may alternatively be carried out in advance before a user gives an instruction for display of a program list.

The pre-filtering process performed at step S2 in FIG. 7 will now be described with reference to the flow chart shown in FIG. 8.

At step S11, the pre-filtering process section 33 focuses on information of one program and slices out information of a part “detailed description of program” included in a “title” field of information of the program of interest. The pre-filtering process section 33 stores the information thus sliced in a memory and manages the same as information “program details 3”.

FIG. 9 is an illustration showing an example of information of one program.

As shown in FIG. 9, information of one program includes three types of information, i.e., a “title” field f₁, a “program details 1” field f₂, and a “program details 2” field f₃.

The title and the sub-title of the program are described in the “title” field f₁. Part of information representing the content of the program is also described in the “title” field f₁, and the description constitutes the “detailed description of program”.

A sentence which is updated as described above may be described as the “detailed description of program”. At the pre-filtering process, information described as the “detailed description of program” is also managed as information belonging to “program details 3” such that the information will be treated as original text data from which a presentation sentence is extracted.

The names of people featured in the program, the name of the producer of the program, and the like are described in the “program details 1” field f₂, and an outline of the program and the like are described in the “program details 2” field f₃.

Referring to FIG. 8 again, at step S12, the pre-filtering process section 33 deletes characters and symbols to be deleted from text data described in the “program details 1” field f₂, and text data described in the “program details 2” field f₃, and text data of the “detailed description of program” stored in the memory as information of “program details 3”. For example, characters representing the name of a broadcast station and a symbol indicating that a weather forecast is featured in the program may be deleted. A dictionary showing characters and symbols to be deleted is provided in the pre-filtering process section 33.

When there are conditions for pre-filtering, at step S13, the pre-filtering process section 33 narrows down the data to obtain information of programs which meet the conditions.

For example, when the process is conditioned such that a list showing only information of programs of a certain channel will be displayed, information is narrowed down to select only pieces of information of programs broadcast by the channel. When the process is conditioned such that a list showing only information of programs broadcast on and after a certain day will be displayed, information is narrowed down to select only pieces of information of programs broadcast on and after the day (broadcast starting day). When the process is conditioned such that a list showing only information of programs belonging to a certain category, e.g., only information of news programs, will be displayed, information is narrowed down to select only pieces of information of programs belonging to the category.

Information of programs which meet the conditions is supplied from the pre-filtering process section 33 to the presentation sentence extracting section 34. Thereafter, the process returns to step S2 shown in FIG. 7 to perform the processes at step S2 and the subsequent steps.

The above-described process allows a user to select a program to be set for timed recording while checking the content of the program from a sentence displayed on a program list.

When a plurality of sentences are extracted as presentation sentences from information of one program, each of the presentation sentences may be displayed.

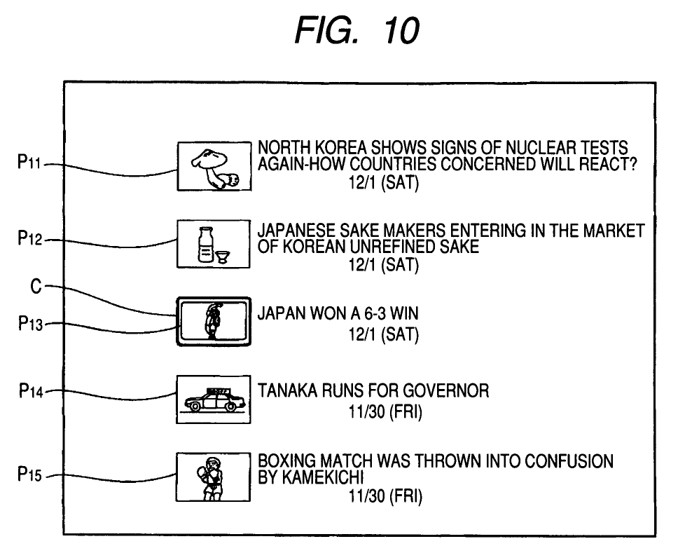

FIG. 10 is an illustration showing another example of a program list. Among the programs represented by pictures P₁₁ to P₁₅ displayed on the program list in FIG. 10, the program represented by the picture P₁₁, the program represented by the picture P₁₂, and the program represented by the picture P₁₃ are the same program scheduled to be broadcast on December 1. The program represented by the picture P₁₄ and the program represented by the picture P₁₅ are the same program scheduled to be broadcast on November 30.

Specifically, the presentation sentence “North Korea shows signs of nuclear test again. How countries concerned will react?” displayed on the right side of the picture P₁₁, the presentation sentence “Japanese sake makers entering into the market of Korean unrefined sake” displayed on the right side of the picture P₁₂, and the presentation sentence “Japan won a 6-3 victory” displayed on the right side of the picture P₁₃ are presentation sentences extracted from information of the same program.

The presentation sentence “Tanaka runs for governor” displayed on the right side of the picture P₁₄ and the presentation sentence “Boxing match was thrown into confusion by Kamekichi” displayed on the right side of the picture P₁₅ are presentation sentences extracted from information of the same program.

When a plurality of presentation sentences are extracted from information of the same program as thus described, each of the presentation sentences may be displayed, which allows a user to find a program having interesting content with reliability higher than when only one presentation sentence is displayed.

Let us assume that a user selects, for example, the program represented by picture P₁₁ in the program list shown in FIG. 10 to make a setting for timed recording of the program. Then, a mark is displayed in a predetermined position, for example, on the left side of the picture P₁₁ to indicate that a setting for timed recording has been made for the program.

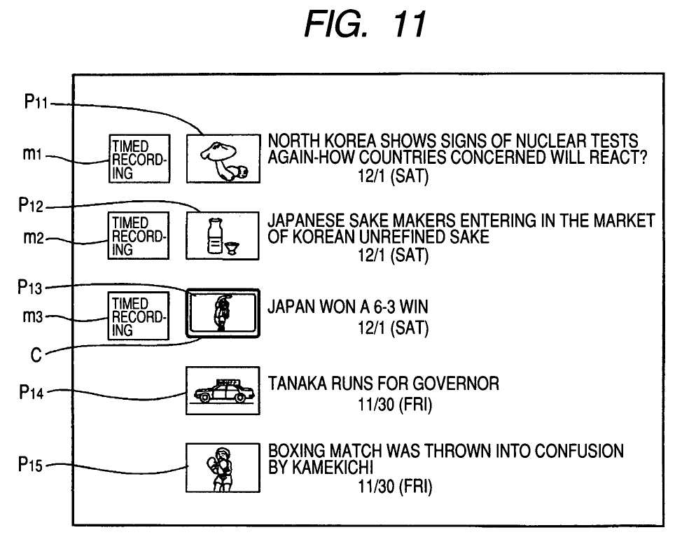

FIG. 11 is an illustration showing an example of a program list displayed when a setting for timed recording has been made for the program represented by the picture P₁₁.

As shown in FIG. 11, a mark m₁ is displayed on the left side of the picture P₁₁ to indicate that a setting for timed recording has been made for the program.

As shown in FIG. 11, since the program represented by the picture P₁₁, program represented by the picture P₁₂, and the program represented by the picture P₁₃ are the same program, a mark m₂ is displayed on the left side of the picture P₁₂, and a mark m₃ is displayed on the left side of the picture P₁₃.

As thus described, when a plurality of sentences are extracted as presentation sentences from information of one program included in EPG data, each of the presentation sentences is displayed. When any one program is selected from among programs each of which has a plurality of sentences representing the content thereof (the programs are the same), information is displayed to indicate that a setting for timed recording has been made for each of the programs whose content is represented by a plurality of sentences.

Thus, the user can understand that the program represented by the picture P₁₁, the program represented by the picture P₁₂, and the program represented by the picture P₁₃ are the same program and that a setting for timed recording has been made for the program.

The above description has addressed display of a program list used for making a setting for timed recording. However, a similar display operation may be performed to show, for example, a list of programs which have already been recorded. Presentation sentences extracted as described above may be displayed on a list of programs which have already been recorded as pieces of information representing the recorded programs, respectively. Thus, a user can select a program to be reproduced while checking the content of the program.

A similar display operation may be performed in various apparatus capable of handling EPG data such as television receivers and personal computers rather than picture-recording apparatus.

The above-described series of processes may be implemented on either hardware basis or software basis. When the series of processes is implemented on a software basis, a program forming the software may be installed in a computer incorporated in dedicated hardware or a general purpose personal computer which is enabled for various functions by installing various programs therein.

The program to be thus installed is provided by recording it in a removable medium 22 shown in FIG. 4 which may be an optical disc (a CD-ROM (Compact Disc-Read Only Memory), a DVD (Digital Versatile Disc), or the like) or a semiconductor memory. The program may alternatively be provided through a wired or wireless transmission medium such as a local area network, internet, or a digital broadcast. The program may be installed in the ROM 12 or the recording section 19 in advance.

The program to be executed by a computer may be a program which allows processes to be executed in a time-sequential manner in the order described in this specification. Alternatively, it may be a program which allows parallel processing or which allows a process to be performed as occasion demands or when there is a call.

It should be understood by those skilled in the art that various modifications, combinations, sub-combinations, and alterations may occur depending on design requirements and other factors insofar as they are within the scope of the appended claims or the equivalents thereof.

What is claimed is:

1. A display control apparatus comprising:
an acquisition section acquiring EPG data;
an extraction section extracting a sentence formed by a plurality of words from information of each item of content included in the EPG data acquired by the acquisition section; and
a display control section causing the sentence extracted by the extraction section to be displayed on a list of content and accepting selection of an item of content.

2. A display control apparatus according to claim 1, wherein the extraction section extracts a sentence having a mark indicating that the sentence is an update of a sentence which has been included in the first information provided in EPG data, among sentences included in information of each item of content.

3. A display control apparatus according to claim 1, wherein when a plurality of sentences are extracted from information of one item of content by the extracting section, the display control section causes each of the plurality of extracted sentences to be displayed on the list of content.

4. A display control apparatus according to claim 3, wherein, when the one item of content is selected from any of the plurality of sentences outlining the item of content extracted from the information of the item of content, the display control section provides an indication showing that the items of content outlined by the plurality of respective sentences are items of content which have already been selected.

5. A display control method comprising the steps of:
acquiring EPG data;
extracting a sentence formed by a plurality of words from information of each item of content included in acquired EPG data; and
causing the extracted sentence to be displayed on a list of items of content to accept selection of an item of content.

6. A program which causes a computer to execute a process comprising the steps of:
acquiring EPG data;
extracting a sentence formed by a plurality of words from information of each item of content included in acquired EPG data; and
causing the extracted sentence to be displayed on a list of items of content to accept selection of an item of content.
